(19) United States
(12) Patent Application Publication
(10) Pub. No.: US 2008/0084317 A1
(43) Pub. Date: Apr. 10, 2008

(54) RFID-based methods and systems to enhance personal safety

(75) Inventors: Sudhanshu Gakhar, Appleton, WI (US); Gary Clement, Menasha, WI (US); Corey Mingerink, Appleton, WI (US); Shawn Sullivan, Neenah, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/544,304

(22) Filed: Oct. 6, 2006

(51) Int. Cl. G08B 23/00; G08B 13/14; G08B 21/00

(52) U.S. Cl. 340/573.4; 340/572.1; 340/686.6; 340/573.6

(57) ABSTRACT

Personal safety of one or more users may be enhanced through the use of RFID tags carried by the users. RFID detectors placed proximate to hazards may detect the approach of users by reading data stored on the RFID tags. Based on data including the skill levels of the users, one or more responses may be specified. User skill levels may be ascertained by identifying a user based on data from one or more RFID tags and consulting stored skill level data associated with the user; alternatively, one or more RFID tags carried by the user may include data specifying the skill level of the user. Responses can be based on multiple conditions, including data from other sensors.

### BACKGROUND

Modern household conveniences can pose many hidden dangers to certain individuals. For example, common household items render a house an exciting place to infants and small children, who love to explore but are not aware of the potential dangers. For example, potential hazards around a household include burns from fireplaces, hot stoves, or other heated items, drowning in a bathtub or swimming pool, and ingesting cleaning supplies or other hazardous chemicals from a medicine cabinet or other storage area. Furthermore, drowning is commonly regarded as one of the leading causes of injury-related deaths for children below five years of age; statistics show that hundreds of children every year drown or are otherwise seriously injured in residential swimming pools.

Various attempts have been made to address the dangers posed by various household items. For example, systems exist that sound alarms, place telephone calls, send messages, or otherwise alert swimming pool owners or other responsible authorities that a person or persons have approached or entered a swimming pool. For example, some systems utilize ultrasonic sensors to detect the presence of a person in a swimming pool; other systems use sensors that detect the displacement of waves; while other systems use motion detectors to determine whether a person or persons have entered a perimeter surrounding the pool.

Still further systems use radio-frequency-based detection of individuals. For example, U.S. Pat. No. 6,064,309 discusses a swimming pool drowning prevention safety system comprising an article wearable by a person, a radio frequency transmitting device coupled to the article for transmitting a radio frequency signal, a microprocessor controlled radio frequency receiving station for receiving the radio frequency signal from the radio frequency transmitting device when the radio frequency transmitting device is within a user-adjustable radio reception range of the receiving station, and an alert signaling device for signaling when the person wearing the article has come within the radio reception range.

Other prior attempts have also used radio-based systems for tracking and monitoring persons of interest. For example, in U.S. Pat. No. 6,753,782, a system is provided for monitoring the behavior and movements of patients with Alzheimer's disease or other conditions characterized by impaired judgment. Patients or other monitored persons wear a transmitter that comprises a radio frequency identification device (RFID) that may be regarded as a personal identification unit. Detectors are placed at strategic locations and proximal or juxtaposed to hazards such as stoves and automobiles accessible to the patient. The detectors detect the proximity of the patient based on the strength of reception of the signal from the transmitter and may provide for one or more responses based on such proximity, such as notifying a caretaker. If a patient approaches a hazard, such as an electrical appliance, based on the proximity of the patient, a controller may activate a relay switch to deactivate the electrical appliance.

U.S. Pat. No. 6,825,767 discusses the use of RFID devices in the context of monitoring user well-being. Such a system may be used as an electronic boundary for keeping track of the distance between a user and another user or a defined boundary area. The signal from the RFID device carried by the user may be correlated to the identity of the user, and exclusion zones or other alert situations may be defined based on detection of an identified user or users in certain areas.

However, generally speaking, presently-existing safety systems provide for user-specific responses on the basis of the user's identity without regard to factors such as the skill level of the user. For example, a swimming pool safety system may be configured to activate an alarm upon the detection of a person within range of the pool. However, if the person within the range of the pool is a capable swimmer, no alarm would be necessary, as compared to the case when the person in proximity to the pool is an infant. Certain presently-existing systems address such a scenario by defining rules based on the identity of the user as detected from the RFID (or other) device. For example, the swimming pool may include a monitor that can detect an identifier associated with the user and look up one or more defined responses based on the user's identity.

However, an identity-based system is dependent upon associating responses with the particular identities of the users. For example, a user of a first swimming pool may be defined in the first swimming pool's safety system such that his presence near the pool does not trigger an alarm. However, if the user goes to a second swimming pool, the user may trigger the second pool's alarm unless the second swimming pool has access to data identifying the user as being allowed near the pool. Depending on the default settings of the system, unknown users may be over- or under-protected.

Therefore, it is apparent that further improvements to systems for personal safety around swimming pools and other hazards remain desirable.

### SUMMARY

Objects and advantages of the present invention will be apparent to one of skill in the art upon careful review of the disclosure. Such objects and advantages include providing systems and methods for users to enhance personal safety around swimming pools and other hazards.

A method of enhancing personal safety can include sensing the proximity of at least one RFID tag and reading data stored thereon. For example, proximity may be sensed by one or more detection units. A detection unit may include any suitable combination of RFID reader module(s) and antenna(s). One or more detection units are placed at or near the location of a potential safety hazard, such as a swimming pool, fireplace, stove, storage area for hazardous materials, or other household dangers so that the detection unit(s) can sense the proximity of one or more protected persons by reading one or more RFID tags associated with each person.

At least one RFID tag is associated with at least one protected person. However, one or more RFID tags may be associated with any particular person, and the method may be utilized to enhance the safety of one or more protected persons. Each protected person is associated with one or more skill levels. The skill levels may be defined in any suitable manner, and may be generic/standardized, custom-defined, defined globally with respect to hazards, or hazard-specific.

The method further comprises defining a safety response model, with the safety response model specifying at least one action to be implemented when a protected person is detected within range of a potential safety hazard. The action is determined at least in part based on determining the skill level of the protected person. The skill level may be determined by cross-referencing the identity of a detected person with stored data indicating the person's skill level, with the identity of the detected person determined based on reading one or more RFID tags. Alternatively or additionally, the skill level data may be stored on the RFID tag(s) directly, and the skill level may be determined based on reading the skill level data from the RFID tag(s) as part of detecting the protected person within range of the potential safety hazard.

The method further comprises sending at least one signal to implement at least one action in accordance with the safety response model, such as sounding an alarm, securing an area containing hazardous or dangerous materials, or sending a message to authorities.

As noted above, the method may include associating one or more RFID tags with each of a plurality of protected persons, with at least some of the protected persons in the plurality having different skill levels from one another. The safety response model may then include a plurality of different actions with respect to the same potential safety hazard, with the different actions specified for different skill levels. The safety response model(s) may include actions that are specified based on detecting multiple users near the same potential hazard(s) at the same time when at least two of the multiple users have different skill levels.

Actions taken in response to a protected person being near a hazard can include sounding an audible alarm and/or sending a pre-determined message via a communication system, such as telephone, Internet, fax, e-mail, text messaging, pagers, and the like. Other actions include engaging (or disengaging) a locking mechanism, such as a solenoid on a cabinet, or de-energizing an electrical circuit, such as by energizing or de-energizing a relay to interrupt the flow of electrical current to an appliance. The safety response model may provide that alarms are combined, changed, and escalated in intensity based on responses (or lack thereof) and additional sensor data.

The safety response model may be further configured to define actions based on sensor data from one or more secondary sensors or alarm systems. For example, the secondary alarm systems or additional sensors may detect the presence of a person in an area, such as by motion detector or by photo detector. A secondary alarm system may detect the opening of a cabinet or door, or may include a wave or splash sensor in a swimming pool.

When the potential safety hazard comprises a swimming pool, a plurality of detection units may be provided to form a perimeter around the pool. The skill level information associated with each user may specify each protected person's swimming capabilities, with the safety response model specifying different actions to be implemented upon the detection of different persons based on such person's swimming capabilities. The method may further comprise determining whether a protected person is in the swimming pool, with the safety response model including at least one action to be implemented when a protected person is determined to be in the swimming pool. For example, a person may be determined to be in the swimming pool by way of a secondary alarm system.

A personal safety system may comprise at least one RFID tag, the tag configured to be carried by a user, at least one detection unit capable of sensing proximity of the at least one RFID tag and reading data stored thereon, and at least one computing device including processing capability and access to a computer-readable storage medium. The computing device may be configured by instructions embodied in the storage medium to perform actions including receiving data from at least one detection unit and accessing a safety response model. The safety response model may define one or more actions to implement upon detection of an RFID tag in proximity to a hazard, with the actions defined based on data including user skill levels. The computing device may be further configured to determine at least one action to implement upon detection of a user in proximity to a safety hazard based on the safety response model and received data and to send one or more signals to implement the at least one action. The RFID tag may store data including data indicating a user's skill level, with the skill level data being provided to the computing device by the detection unit.

The system may comprise a plurality of detection units connected to the same computing device, with the computing device further accessing instructions configuring the computing device to interact with a user and define a safety response model based on user input. The computing device may further include hardware and software to read and program RFID tags with data, such as user skill level data. The plurality of detection units and the computing device may be connected to one another by way of a local area network or any other suitable connection methodology.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 illustrates exemplary hazards and exemplary components of a system for enhancing personal safety relative to the hazards;

FIG. 2 is a functional block diagram depicting an arrangement of components in an exemplary embodiment of a system for enhancing personal safety;

FIG. 3 is a functional block diagram depicting an arrangement of components in an alternative exemplary embodiment of a system for enhancing personal safety;

FIG. 4 is a functional block diagram depicting an arrangement of components in another alternative exemplary embodiment of a system for enhancing personal safety.

Use of like reference numerals in different features is intended to illustrate like or analogous components

### DETAILED DESCRIPTION

This disclosure now makes reference in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

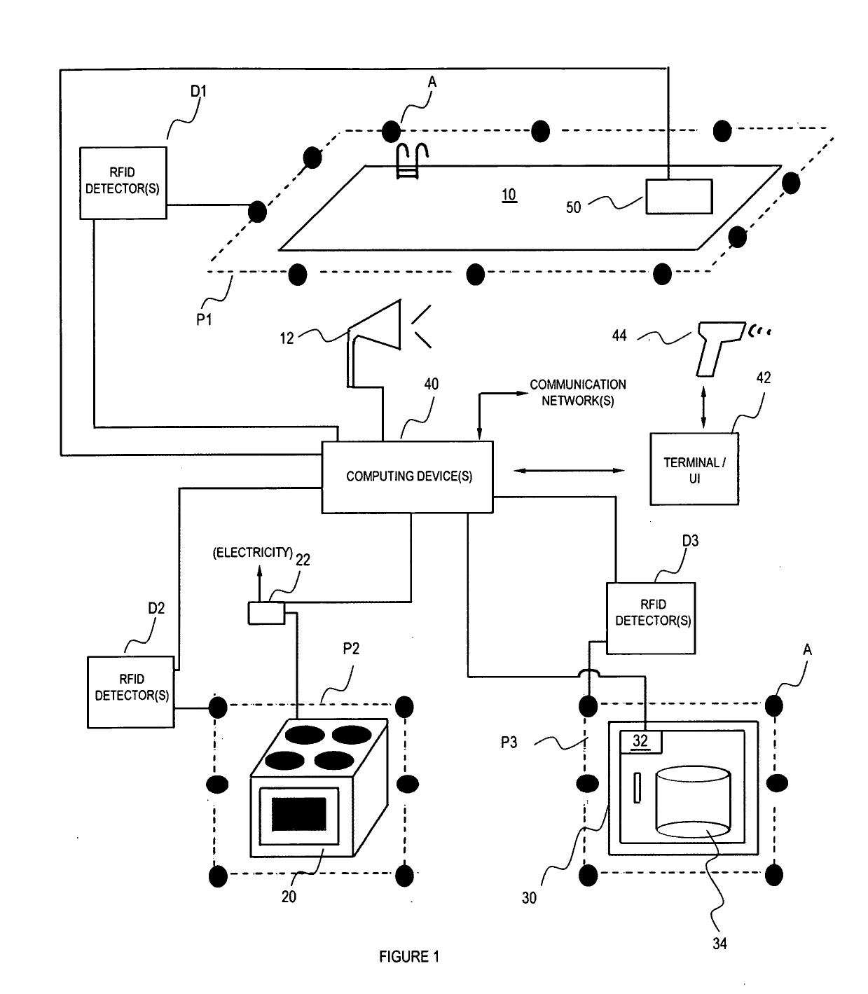

FIG. 1 illustrates three exemplary household hazards, the danger of which may be reduced by way of embodiments of the presently-disclosed methods and systems. However, it will be apparent to one of ordinary skill in the art that the technology discussed herein is applicable to any number and variety of household hazards and dangers, and to hazards and dangers located outside the household. For example, such additional hazards could be other localized dangers such as fireplaces, grills, and bathtubs and/or dangerous areas such as garages, workshops, and the like. The examples discussed herein refer to users and protected persons interchangeably and generally refer to children. However, one of skill in the art will recognize that the present subject matter can be used to enhance the safety of any individuals, and may be applicable to non-humans as well (e.g. pets).

FIG. 1 shows three hazards: swimming pool 10, household range 20, and cabinet 30 housing hazardous material 34. Hazardous material 34 represents any material or substance which could pose a hazard to children (or other individuals), such as household cleaners, other chemicals such as pesticides, or even substances such as alcohol. Cabinet 30 may further or alternatively store other dangerous items, such as tools and sharp knives, firearms, or other dangerous instrumentalities.

FIG. 1 further illustrates components in an exemplary system for enhancing personal safety with regard to dangers posed by swimming pool 10, range 20, and the contents of cabinet 30. These components will be discussed in further detail in the examples provided below, and include RFID sensors D1, D2, and D3, which establish respective perimeters P1, P2, and P3 around hazards 10, 20, and 30. Each perimeter is established in this example by a plurality of antennas A which are connected to respective detectors. For instance, if UHF RFID tags are utilized, the antenna may comprise a circularly polarized patch antenna operating at frequencies including the UHF frequency band (902-236 MHz). However, antenna arrangement and placement may be varied without departing from the spirit and the scope of the present technology. Detectors D1, D2, and D3 are configured to detect when one or more persons associated with an RFID tag enters perimeters P1, P2, and P3 by reading one or more RFID tags associated with each person. As will be noted below, the tag or tags may be carried on or by each person directly and/or integrated into items carried on or by each person.

By way of example, suitable detectors include any RFID reader module or combination of modules that support the type or types of RFID tags used with the system. For instance, suitable readers could include any reader that supports EPC Generation 2 protocol, such as the Thingmagic Mercury 4e/h reader, available from Thingmagic, Inc. of Cambridge, Mass. One of skill in the art will appreciate that the RFID reader(s) and antenna(s) utilized in association with the present subject matter may be of any suitable size, shape, type, or origin so long as the reader(s), antenna(s), and tag(s) are appropriately configured and otherwise compatible.

Based on data obtained from the detectors and one or more predefined safety response models, various actions may be taken to protect users from the hazards posed by hazards 10, 20, and 30. In the examples discussed herein, these actions include activating alarm 12, interrupting the supply of electricity to range 20 by way of circuit breaker 22, and engaging solenoid 32 to lock cabinet 30 and thereby prevent access to hazardous item 34. However, any number and combination of suitable actions may be defined in a safety response model and implemented using appropriate hardware and software.

FIG. 1 further illustrates processor unit 40, user terminal 42, and RFID read/write device 44. These components represent any combination of hardware and software that allow users to scan RFID tags and program the RFID tags with information used to implement the methods and systems of enhancing personal safety discussed herein. In this example, processor unit 40 comprises one or more computing devices interfacing with other components in the system and storing data including data defining safety response model(s). Processor unit 40 may further store data including user data such as user skill levels. However, as will be discussed in examples below, user skill level data may be included in data stored on one or more RFID tag(s) associated with each user. Accordingly, in some embodiments, processor unit 40 need not necessarily store any user-specific data, since the safety response model(s) could be minimally defined on the basis of user skill level(s) only.

Processor unit 40 may be located at the same site as the remaining components of the system, or may be remote. For instance, in some embodiments, processor unit 40 may comprise a remote server unit including memory for storing one or more safety response models, with the remote server interfaced with one or more local processing units providing connections to the various RFID and other sensors and output connections to mechanisms for implementing safety response actions.

User terminal 42 represents a computing device configured to allow a user to: specify the extent of perimeters P1, P2, and P3; define responses to be taken when users approach hazards 10, 20, and 30; and provide user information including user skill levels. User terminal 42 may comprise a local computer interfacing to processor unit 40, which, as noted above, may be located on-site or remote from user terminal 42. User terminal 42 may, for example, represent a desktop, laptop, tablet, or portable computer (such as a PDA) including a user interface that allows a supervisory user to define parameters for one or more safety response models. For example user terminal 42 may provide an interface and relay data to and from processor unit 40.

In some embodiments, processor unit 40 and user terminal 42 may comprise the same device, such as a general-purpose computer such as a desktop or laptop computer. In such embodiments, the computer could include appropriate hardware connections to sensors and response mechanisms and also software for storing and implementing the safety response model(s) and interacting with the supervisory user(s).

As will be discussed in further detail below, various embodiments of the presently-disclosed technology utilize different combinations and configurations of the components illustrated in FIG. 1.

The technology discussed herein makes reference to servers, databases, software applications, and other computer-based systems, as well as actions taken and information sent to and from such systems. One of ordinary skill in the art will recognize the inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel. When data is obtained or accessed between a first and second computer system or component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile that the second computer uses to access the actual data from a computer other than the first computer, for instance.

The present disclosure also makes reference to the relay of communicated data over communications networks such as the Internet. It should be appreciated that such network communications may also occur over alternative networks such as a dial-in network, a local area network (LAN), wide area network (WAN), public switched telephone network (PSTN), the Internet, intranet or Ethernet type networks and others over any combination of hard-wired or wireless communication links.

The various systems discussed herein are not limited to any particular hardware architecture or configuration. Any suitable programming, scripting, or other type of language or combinations of languages may be used to implement the teachings contained herein. Suitable computing devices include multipurpose microprocessor-based computer systems accessing stored software, application-specific integrated circuits and other programmable logic, and combinations thereof.

As a general principle, RFID tags which are utilized in embodiments of the present systems and methods may be of any configuration. For example, the tags may comprise active, semi-active, or passive RFID tags. The tags may be configured as wearable items, such as bracelets or ankle tags. The tags may be integrated into other products that are initially not associated with the personal safety enhancement system. For example, suitable RFID tags may include passive RFID tags embedded into clothing products or other personal items, such as tags originally included with an item to identify the item for inventory, sale, or other purposes. By way of example, suitable RFID tags include those sold by the Avery Denison Corporation RFID Division of Clinton, S.C., such as the AD-220 Gen2 UHF RFID tag. However, one or skill in the art will appreciate that the RFID tags utilized in association with the present subject matter may be of any suitable size, shape, type, or origin, so long as such tags are compatible with the arrangement and configuration of the RFID reader(s) and antenna(s) comprising the system.

Regardless of origin, RFID tags are initially programmed for use with the personal safety enhancement system. The tags may be programmed or reprogrammed as part of a “check-in” process by a supervisory user using RFID read/write device 44 and terminal 42 and processing device 40. However, it will be appreciated that RFID read/write device 44 may be dispensed with if at least one of detectors D1, D2, or D3 is capable of reading and writing RFID tags. In such a case, the check-in process could be performed at a suitable computer terminal, with the RFID tag reading and reprogramming performed by one of detectors D1, D2, or D3 in concert with processing unit 40 and/or terminal 42. Alternatively, pre-programmed tags may be made available for use by a supervisory user, for example, tags with data for use in conjunction with a “generic” safety response model.

In some embodiments, as part of the setup of the system, a supervisory user will also have to define at least one safety response model. The safety response model comprises one or more actions to be implemented when a protected user is detected within range of a safety hazard. Safety response models may be implemented in any suitable fashion that sets forth conditions and actions to be taken when such conditions are met. For example, a safety response model may define one or more hazard areas associated with one or more particular sensors. The model may further provide for one or more actions to be taken when a particular user is detected in or near a hazard based on identifying the user from RFID tag data and consulting a database or other record of information specifying the user's skill level. Alternatively, the actions may be based on a direct correlation of a skill level and a hazard based on reading skill level data stored on and read from the RFID tag(s).

For example, the safety response model may define a plurality of actions to be taken upon detection of users within range of swimming pool 10. The actions may include sounding alarm 12, or sending a notification to a supervisory user or rescue authorities. Actions that may be taken in response to a user being detected near range 20 may include sending a signal to circuit breaker 22 to interrupt the flow of current to range 20. Actions which may be implemented in response to detection of a user near cabinet 30 may include sending a signal to solenoid 32 such that cabinet 30 is locked and access to item 34 is prohibited.

The safety response model may be configured to tailor responses to the skill level of particular users. For example, if a supervising user wishes to enhance the safety of two children, the appropriateness of a particular action may depend upon the age and skill level of each of the children. For example, with regard to swimming pool 10, an infant may generally require greater protection than a child with at least some swimming capabilities. Accordingly, the safety response model may be configured so that when the child with swimming capability enters perimeter P1, alarm 12 may be sounded to play a pre-recorded warning directing the child away from the pool. However, if an infant is detected within range of perimeter P1, a message may be sent to several supervisory users and alarm 12 may be activated to send an alert siren. If a highly skilled swimmer is detected near pool 10, the safety response model may be configured such that only a notification message is sent to a supervisory user, or no action is taken at all unless further conditions are met.

Similarly, the safety response model may specify different actions for different users with regard to range 20 and/or cabinet 30. For example, a child of suitable age may be allowed to contribute to household activities such as cooking and cleaning. To accommodate such a situation, the safety response model may be configured to send a message to a supervisory user when the skilled child is within range of range 20 and cabinet 30, but to still allow access and use the range and cabinet. For example, the safety response model may be configured to allow access to range 20 and cabinet 30 during pre-determined time periods (such as when a parent is home) but to disallow access during other time periods. However, with regard to an infant, the safety response model may provide that range 20 and cabinet 30 always pose a hazard, so the system will be configured to deactivate range 20 and lock cabinet 30 at any time an infant is detected within range of such hazards.

In some embodiments, the safety response model may specify actions based on detection of multiple users in proximity to one another and one or more hazards. For example, the safety response model may be configured to implement one or more different actions if a protected user of a first skill level is accompanied to a hazard by another user of another skill level. Using the examples above regarding a child assisting in household activities, assume that the child is skilled enough to handle the range and chemicals, but only under parental supervision. In addition to or in alternative to specifying pre-determined time periods, a safety response model may be configured to allow access to range 20 and/or cabinet 30 for the child when a parent (or other user of sufficiently-high skill level) is also detected in proximity to range 20 and/or cabinet 30. In such embodiments, the parent (or other user) would, of course, carry one or more RFID tags suitably associated with the system such that the system could determine the parent (or other user's) skill level(s) relative to the hazards. One of skill in the art will appreciate that a wide variety of actions may be specified based on detection of multiple users in proximity to one or more hazards based on the skill level(s) of the multiple users.

It also will be appreciated that the safety response model may include parameters other than those discussed in the examples herein. For example, in addition to the user skill level, actions may be defined on the basis of other factors including time of day, day of the week, user identity, and the like. Actions may be further specified based on input from sensors and sources other than detectors D1, D2, and D3, such as the status of one or more secondary alarm systems associated with each hazard. The safety response model may also specify conditional or global exceptions.

For example, swimming pool 10 may include additional sensors, such as wave or splash sensors configured to detect the presence or absence of a person in the pool. If a protected user is detected within perimeter P1 and the splash or wave sensor indicates that an object greater than 15 pounds has entered pool 10, the response may be greater in intensity than if a user is detected within the perimeter but no activity in the pool is detected. For example, if the secondary alarm system indicates that a protected user has fallen in the pool, the systems may immediately contact emergency authorities, such as by dialing 911 and providing a pre-recorded message.

Similarly, secondary alarms systems may be associated with range 20 and/or cabinet 30. For instance, a heat sensor may determine whether range 20 has been activated by a user within perimeter P2, and/or a door sensor may indicate whether the range door has opened. If such activities are occurring, the response may be increased in intensity. Cabinet 30 may be associated with a door sensor as well to determine whether a user has opened a door to access hazardous material 34. Additionally, for any or all of hazards 10, 20, and 30, perimeters P1, P2, and P3 may be further monitored by additional sensors such as infrared or other motion sensors. Such secondary sensors may be used to confirm whether a user has entered the prohibited areas surrounding each hazard or, for example, is only near the perimeter but not yet in any real danger.

The safety response model may be configured to provide an initial response and then escalate with one or more further responses based on continuing monitoring the RFID detectors and other secondary sensors. Returning to the example of the semi-skilled child near pool 10, if the child ignores the initial response (pre-recorded warning), the system may be configured to play the warning again if the child still remains near the pool. If the child enters the pool (as indicated by, e.g., wave/splash sensors and/or motion detectors), a message may be sent to a supervisory user.

Although the present disclosure uses the term “the” safety response model, it will be understood that safety response models may take multiple logical forms. For example, a safety response model may be defined for individual hazards, for multiple hazards at a single location, or globally by hazard type. A particular system may utilize one safety response model or several models in combination. Similarly, user skill levels may be custom-defined, hazard-specific, or hazard-generic. In some embodiments, user skill levels may be defined in a standardized manner. User skill levels may be defined in any suitable fashion; for instance, the system may define user skill levels on the basis of data input regarding the user's age, capability, judgment, etc. The system may have overall configuration parameters, such as on/off times, or may switch between safety response models on a pre-scheduled basis and/or in response to user input. For example, when a supervisory user is at swimming pool 10, the user may deactivate all alarms; this could be through manual intervention or specified as part of the model.

The safety response model may be implemented using any suitable combination of hardware and/or software. For example, the parameters and conditions defining the safety response model(s) and user characteristics may be stored in one or more databases, computer files, and/or other machine-readable format(s). Functionality for implementing the safety response model(s) may be provided by one or more applications or processes implemented in any suitable fashion, including via executable files, scripts, drivers, or a combination of such components, for example.

For example, one or more processes or applications may be configured to monitor the status of the RFID and other sensors or await active messages from the sensors. Such processes or applications may actively poll the sensors at regular or irregular intervals or may continuously monitor the sensors for changes in status. Additional applications and/or processes may obtain or receive sensor data and access the safety response model(s) to evaluate whether one or more actions are to be implemented; such evaluation(s) may occur continuously, at regular or irregular intervals, or upon the receipt of data from sensors (such as interrupt or other messages indicating a change in sensor status, for instance). Still further applications and/or processes may monitor the status of the various response systems and mechanisms (such as alarm 12, circuit breaker 22, and lock 32) and provide appropriate signals to the response mechanisms and systems based on the results of evaluating the safety response model and sensor data. Additional software may provide for network connectivity and user interface and interaction. As noted earlier, software functionality discussed herein may be implemented using any suitable combination of applications, processes, and the like. For example, the above-discussed processes/applications may be integrated into a single application, may comprise modular components, or may be otherwise distributed or combined in any suitable fashion.

Perimeters surrounding safety hazards such as pool 10, range 20, and cabinet 30 may be established through any suitable sensor configuration and placement. Although illustrated in FIG. 1 as rectangular perimeters, one of skill in the art will appreciate the perimeters may be any suitable size or shape. Detectors D1, D2, and D3 may be range-sensitive or otherwise configured to detect range such that perimeters P1, P2, and P3 are adjustable. As a further example, multiple perimeters could be defined based on multiple sensors. A combination of fixed and adjustable perimeters may be used, as well. For example, perimeter P1 may be established by a plurality of detector units strategically positioned around the swimming pool, with the hazard area comprising the area surrounding each detector. Alternatively, an inductive loop antenna may be buried or positioned to define the perimeter.

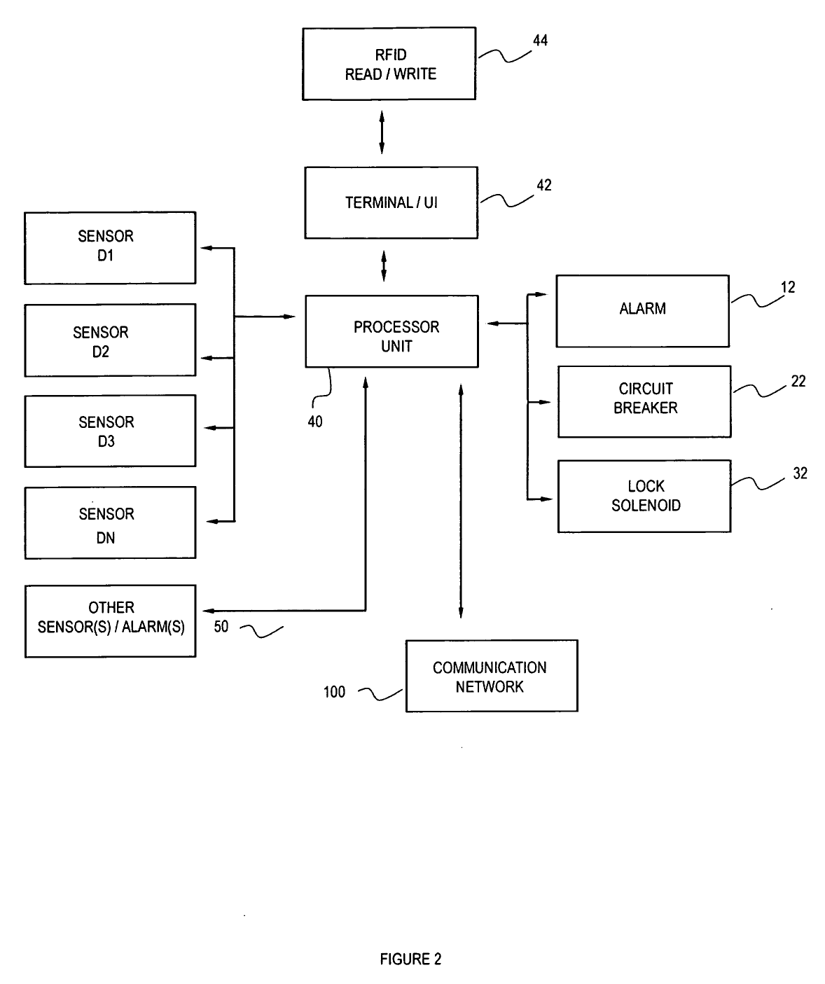

FIG. 2 is a block diagram illustrating an exemplary arrangement of the components depicted in FIG. 1. In the arrangement of FIG. 2, sensors D1, D2, and D3 are linked together on a common communication bus and are connected to processor unit 40. However, multiple communication busses may be used, or each sensor may connected to processor unit 40 directly. Suitable connections may be compliant with standards such as USB, IEEE 1394, or other computer interface and connection protocols. Alternatively, customized interface hardware and communication protocols may be used. For example, sensors may connect to a customized or standards-compliant hub that interfaces to processor unit 40.

FIG. 2 also illustrates a sensor labeled as DN to point out that the system may be utilized with more sensors than are discussed in the present example. Processor unit 40 is further linked to other sensors 50, which may include, for example, secondary alarm systems such as the wave sensor associated with pool 10 and the cabinet door sensor associated with cabinet 30. Processor unit 40 is further linked to user terminal 42 which is linked to RFID read/write device 44. Processor unit 40 is further linked to circuit breaker 22, alarm 12, and lock solenoid 32 by any suitable hardware component(s), such as by custom or standardized communication interfaces. For example, as an alternative to standard communication and interface protocols for computer hardware, home automation protocols may be suitable. Alternatively, the system may utilize standardized or proprietary industrial automation interface protocols and hardware standards.

Processor unit 40 is also connected to communication network 100, which may include the Internet, telephone system, or any other suitable medium by which processor unit 40 may send and receive data. For example, communication network 100 may comprise the telephone connection used by processor unit 40 to report the presence of a protected user in pool 10. Processor unit 40 may, of course be connected to multiple communication mediums at once.

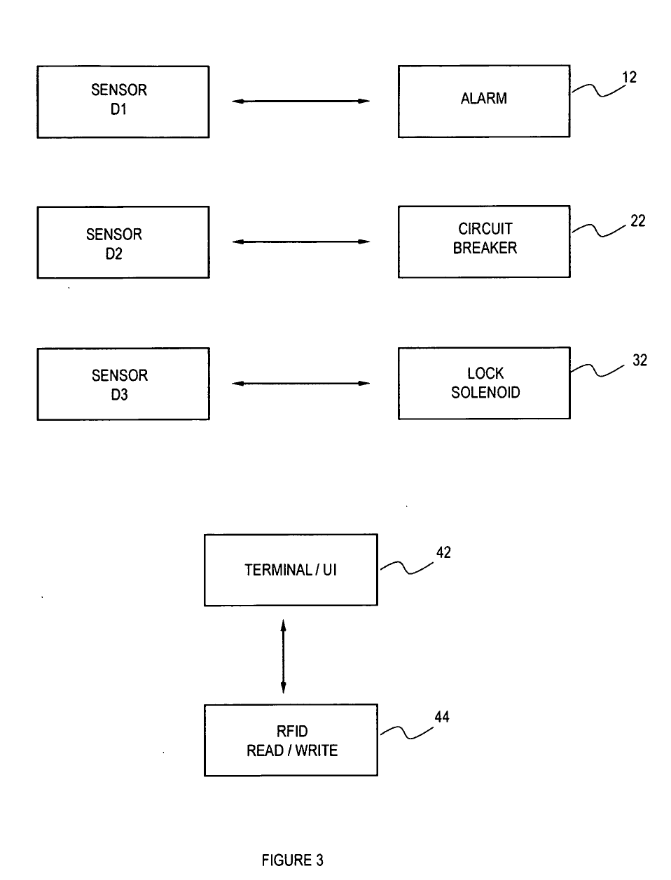

FIG. 3 illustrates an alternative arrangement of components used to monitor the exemplary hazards 10, 20, and 30 illustrated in FIG. 1. In this example, the sensors associated with each hazard are linked directly to mechanisms used to implement safety response actions. For instance, each sensor may include minimal processing and memory capability to evaluate and determine the appropriate response and additional hardware and/or logic to implement an appropriate response directly, as well. For example, each sensor may be associated with a microcontroller and memory storing a safety response model. Upon detection of a user within range of each sensor, each sensor can send a signal directly to its respective response mechanism. FIG. 3 further illustrates user terminal 42 and RFID read/write device 44, which may be used to define a safety response model and reprogram RFID tags with suitable data. User terminal 42 may be used to provide the safety response model to each of the sensors. For example terminal 42 (or processing unit 40, which is not shown in this example) may be connected to each sensor by a wired or wireless link.

Alternatively, each sensor may have access to a generic safety response model including several actions associated with particular skill levels. User terminal 42 could be configured to program RFID tags with skill levels corresponding to those specified in the generic safety response model based on user selection. As noted above, pre-programmed tags corresponding to the generic safety response levels may also be available and suitable for use in the system. One of skill in the art will note that the “generic” safety response model and/or “generic” RFID tags may be suitable for use in any embodiments (or combinations or variants thereof) discussed herein.

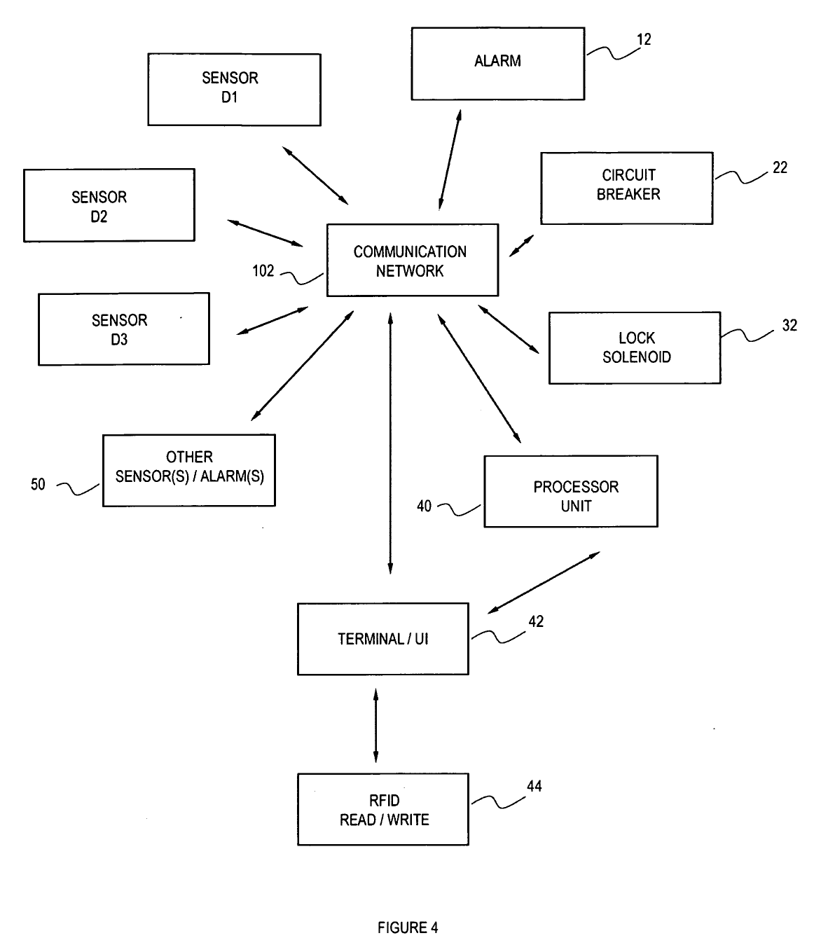

FIG. 4 illustrates another exemplary arrangement of components suitable for use with a system for enhancing personal safety. In the embodiment shown in FIG. 4, the sensors, action mechanisms, processor unit, and user terminal are all linked to communication network 102. Communication network 102 may, for example, comprise a local area network. Alternatively, communication network 102 may comprise a wide area network such as the Internet. Each component in the safety response system could be associated with a network identifier, such as an IP address, and be connected into the network by way of wire or wireless links.

In embodiments in which network 102 is a local network, one or more components illustrated in FIG. 4 may be further connected to outside communication networks, such as communication network 100 discussed in conjunction with embodiments above.

### EXAMPLE

The following example is provided for purposes of illustration only. In this example, a supervisory user P wishes to enhance the household safety of two children: infant I and child C with regard to a swimming pool, range, and storage cabinet housing cleaning chemicals.

Initially, a personal safety enhancement system is set up by strategically placing RFID antennas around the perimeter of P's pool. The antennas are linked to an RFID reader that is connected to a computer. In this example, P uses a home computer to supervise the system, although, as noted earlier, the system could be configured with some or all components being network-based. An alarm is further connected to the computer and positioned near the pool. P also purchases a cabinet or retrofits an existing cabinet to include a remotely-triggered power lock. P positions a second RFID antenna and reader near the cabinet, and connects the power lock and second RFID reader to the computer.

P activates one or more software applications using the computer to further configure the system. P initially defines the protected users I and C. The software application allows P to provide various information about I and C, including skill levels. For example, the software prompts P to enter the ages of I and C, which are, in this example, 2 and 11, respectively. Based on the ages and other information, the system automatically creates a profile of I and C and assigns skill levels of (IV—Minimal Skill) to infant I and (III—Low Skill) to child C.

P may adjust the skill levels in his or her discretion. For example, C may have attended swimming lessons or is otherwise viewed by P as additionally skilled, and so P may change C's skill level to (II—Moderate Skill). The system may support global skill levels for each user and/or may allow supervisory users to specify skill levels for specific hazards. In this example, P may specify both a default skill level and, if desired, hazard-specific skill levels. P specifies C's default skill level as (III—Low Skill), but adds additional data indicating C's skill level regarding the pool as (II—Moderate Skill (Pool Only)). P assigns a skill level of (I—High Skill) to him or herself.

Also as part of configuring the system, P may define one or more safety response models. In this example, a single model will be used. P specifies desired responses based on particular hazards and the skill level of the person approaching such hazards.

In this example, P configures the system to sound an alarm if low-skilled persons such as infant I approach the pool under any circumstances. However, if child C approaches the pool, the system may first play a recording, such as P's voice, directing the child away from the pool. In this example, as noted above, the system treats C as having skill level of (II—moderate) with regard to the pool, but a skill level of (III—Low) regarding other hazards. The recording may be specific to child C or generic; P may make or select the recording as part of the setup process. P further specifies that, if child C (or other approaching person) does not heed the no-approach warning (i.e. continues to be detected), a supervisory user is notified.

Regarding the chemical cabinet, P specifies that the cabinet door locks if any user other than one having a skill level of (I—advanced) approaches the cabinet. However, to enable C to help clean on Saturday mornings under the supervision of P, P specifies an exception. P's exemplary entries are provided in the table below, although any particular format may be used to enter and display parameters for the response model(s). As for the range, P specifies that C may use the range only if C is assisting P in cooking (i.e. only if P is also in proximity).

TABLE 1
P's Safety Response Model

| Hazard | Condition 1 | Condition 2 | Action |
|---|---|---|---|
| Pool | Skill Level = III or | | Sound alarm |
| | IV detected | | |
| Pool | Skill level = II | | Play no-approach |
| | detected | | warning |
| Pool | Skill level = II | User = child C | Play specific no- |
| | detected | | approach warning |
| | | | for C |
| Pool | Skill level = II | Warning already | Send alert |
| | detected | played | message to |
| | | | supervisor |
| Cabinet | Skill level II, III, or | | lock cabinet |
| | IV detected | | |
| Cabinet | Skill level III | Between 8:00 AM | no action (cabinet |
| | detected | and 10:00 AM on | unlocked) |
| | | Saturday | |
| Range | Skill level III | Skill level I also | no action (range |
| | detected | detected | active) |

The safety enhancing system may be implemented alongside other systems, for example, as part of a burglar alarm or other conventional safety system(s). For instance, the system may further provide for an alarm to sound if any person approaches the pool at night based on a motion sensor, or if a splash is detected in the pool but no motion is detected afterwards, which could indicate a drowning.

One of skill in the art will appreciate that the conditions and actions may be specified in any suitable manner. For instance, in this example, some of the conditions are specified using Boolean “AND” relationships between Conditions 1 and 2 and using Boolean “OR” relationships within condition 1. However, other suitable logical operators may be utilized. Furthermore, other logic rule sets and rule definitions may be used to specify the various conditions and actions in safety response models.

Once P has specified protected users and at least some responses based at least in part on user skill levels, P may then proceed to associate RFID tags with protected users. For example, P may program one or more RFID-carrying articles, such as bracelets or anklets for child C and infant I (and P him or herself) to carry or wear. Alternatively, P may purchase pre-programmed RFID articles. The particular data programmed into the RFID tags will vary according to implementations of the system.

For example, the system may be configured to recognize particular users by reading identification data stored on the RFID tag(s) and cross-referencing the identification data to stored information for the particular users. For example, the system may access a database or other store of user profiles based on a user ID number. Based on the user's profile, the user's skill level(s) may be determined and the safety response model implemented. Alternatively, the RFID tag(s) may include data specifying the user's skill level(s). The system may then directly access the safety response model on the basis of the skill level. As noted above, responses may be based on skill level alongside other factors, such as user identity.

P may additionally “check-in” items containing RFID inventory or other identification tags and associate such tags with child C and infant 1. For example, P may purchase a package of diapers for infant 1, with the diapers containing RFID tags. P may use an RFID read/write device to reprogram the tags with data specific to infant I. For example, the RFID tag could be programmed to store data identifying infant I's skill level of (III—Low Skill). P may similarly program other items containing RFID tags such as clothing or accessories with I and C's respective data.

Programming RFID tags with data including user skill levels based on a generic or standardized skill level specification may prove advantageous when users of one system interact with a second system. For example, assume P's neighbor N also has an infant and a swimming pool with a personal safety system programmed to respond based on user skill levels. Further assume N configures his system to be in “high alert” mode during working hours, such that the responses are as follows (N's model for non-working hours is not illustrated in this example):

TABLE 2
N's Safety Response Model (Work Hours Only)

| Hazard | Condition 1 | Condition 2 | Action |
|---|---|---|---|
| Pool | Skill Level = III or | | dial 911, play |
| | IV detected | | alert message |
| Pool | Skill level = I or II | | Play no- |
| | detected | | approach |
| | | | warning |

If, during working hours, P's infant I wanders away and into N's yard, I may be in danger if I approaches N's pool. However, since I's skill level is specified by RFID diaper tags, I's approach will be detected by N's safety response system, even though N's safety response system (in this example) has not been specifically programmed to recognize I individually. One of skill in the art will recognize that RFID tags may be programmed with both a standards-compliant skill level and a system-specific skill level. For example, as noted above, P may have specified that C has a swimming-specific skill level of II. C's RFID tags may be programmed with data including both a standardized skill level (Level III—Low Skill) and P's custom skill level (Level II—Moderate Skill (Pool Only)). However, N's system may not recognize the variance in skill level for pools, and therefore may treat C as having a skill level of (III—Low Skill). Similarly, if N's children approach any hazards specified by P, P's system can implement non-specific responses based on N's children‘s’ skill levels.

It is appreciated by persons skilled in the art that what has been particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed:

1. A method of enhancing personal safety, the method comprising:
sensing the proximity of at least one protected person to a potential safety hazard by reading at least one RFID tag associated with the at least one protected person;
defining a safety response model, the safety response model comprising at least one action to be implemented upon detection of the at least one protected person within range of the potential safety hazard based at least in part on determining the skill level of the at least one protected person; and
sending at least one signal to implement at least one action in accordance with the safety response model after the at least one protected person is sensed within range of a potential safety hazard.

2. The method as set forth in claim 1, wherein determining the skill level of the at least one protected person includes receiving data read from at least one RFID tag associated with the person and indicating the person's skill level.

3. The method as set forth in claim 1, wherein:
a plurality of RFID tags are associated with a plurality of respective protected persons, at least some of the protected persons having different skill levels from one another; and
the safety response model includes a plurality of different actions with respect to the same potential safety hazard, wherein the different actions are specified based at least in part on different skill levels.

4. The method as set forth in claim 3, wherein the safety response model specifies at least one action based upon detection of a plurality of users in proximity to the same hazard at the same time, at least two of the plurality of users having differing skill levels relative to the hazard.

5. The method as set forth in claim 1, wherein the at least one action includes sounding an audible alarm.

6. The method as set forth in claim 1, wherein the at least one action includes sending a pre-determined message via a communication system.

7. The method as set forth in claim 1, wherein the at least one action includes engaging a locking mechanism.

8. The method as set forth in claim 1, wherein the at least one action includes de-energizing an electrical circuit.

9. The method as set forth in claim 1, wherein the safety response model further defines actions to be implemented based on data received from at least one secondary sensor.

10. The method as set forth in claim 9, wherein the secondary sensor comprises a motion detector.

11. The method as set forth in claim 9, wherein the secondary sensor comprises a wave or splash sensor.

12. The method as set forth in claim 1, wherein
the potential safety hazard comprises a swimming pool;
the at least one user skill level includes swimming capabilities; and
the safety response model specifies different actions to be implemented for protected persons based at least in part on their swimming capabilities.

13. The method as set forth in claim 12, further comprising:
determining whether a protected person is in the swimming pool;
wherein the safety response model includes at least one action to be implemented when a protected person is determined to be in the swimming pool.

14. A personal safety system comprising:
at least one RFID tag, the tag configured to be carried by user;
at least one detection unit capable of sensing proximity of the at least one RFID tag to a potential safety hazard, the detection unit further capable of reading data stored on the at least one RFID tag;
at least one computing device including processing capability and access to at least one computer-readable storage medium, the computing device configured to access the computer-readable storage medium and execute computer-readable instructions embodied in the storage medium, the instructions configuring the computing device to perform actions including:
receive data from the at least one detection unit,
access a safety response model, the safety response model defining one or more actions to implement upon detection of an RFID tag in proximity to the hazard, wherein the actions are defined based on data including user skill levels,
based on the safety response model and received data, determine at least one action to implement upon detection of a user in proximity to a particular safety hazard, and
send one or more signals to implement the at least one action.

15. The system as set forth in claim 14, wherein the RFID tag stores data including data indicating a user skill level and said data is provided to the at least one computing device by the at least one detection unit.

16. The system as set forth in claim 14, wherein:
the system further comprises a plurality of detection units connected to the same computing device; and
wherein the computer-readable instructions further configure the computing device to perform actions including:
receive user input,
define a safety response model based on the user input, and
program RFID tags with data including user skill level data based on said input.

17. The system as set forth in claim 14, wherein the plurality of detection units and the at least one computing device are connected to one another by way of a local area network.
